(19) United States
(12) Patent Application Publication
(10) Pub. No.: US 2019/0371208 A1
(43) Pub. Date: Dec. 5, 2019

(54) Educational Globe and Wireless Speaker Device

(71) Applicant: Filter USA Inc., Brooklyn, NY (US)

(72) Inventor: Benjamin Friedlander, Brooklyn, NY (US)

(73) Assignee: Filter USA Inc., Brooklyn, NY (US)

(21) Appl. No.: 15/991,060

(22) Filed: May 29, 2018

(51) Int. Cl. G09B 27/06; G09B 27/08; G09B 5/06; G09B 19/00

(52) U.S. Cl. CPC G09B 27/06; G09B 19/0061; G09B 5/06; G09B 27/08

(57) ABSTRACT

The present invention relates generally to educational devices; particularly, an educational device primarily consisting of an illuminated globe with a wireless speaker and light display capabilities. The educational globe device according to the present invention provides an apparatus primarily developed for the purpose of teaching a child geography and astronomy while further providing entertainment.

### BACKGROUND OF THE INVENTION

The present invention relates generally to educational devices; particularly, an educational device primarily consisting of an illuminated globe with a wireless speaker and light display capabilities. The use of globes for educational purposes is well known in the prior art. The educational globe device according to the present invention substantially departs from the conventional concepts and designs of the prior art by providing an apparatus primarily developed for the purpose of teaching a child geography and astronomy while further providing entertainment.

### SUMMARY OF THE INVENTION

The present invention comprises a novel educational device primarily consisting of an illuminated globe with a wireless speaker and light display capabilities.

The general purpose of the present invention is to provide a new educational globe apparatus which has many novel features that result in a new educational globe device, which is not anticipated, rendered obvious, suggested, or even implied by any of the prior art educational globes, either alone or in any combination thereof.

### BRIEF DESCRIPTION OF THE SEVERAL VIEWS OF THE DRAWINGS

Some embodiments of the present invention are illustrated as an example and are not limited by the figures of the accompanying drawings, in which like references may indicate similar elements, and in which:

FIG. 1 depicts an exemplary embodiment of an activated educational globe;

FIG. 2 shows an exemplary embodiment of a deactivated educational globe

FIG. 3 shows the inner globe surface of an activated educational globe;

FIG. 4 depicts a side view of an educational globe device indicating light and sound locations;

FIG. 5 shows a bottom view of an educational globe device indicating light and sound apertures;

FIG. 6 depicts a top view of an educational globe device;

FIG. 7 shows a front view of an arc support for an education globe device;

FIG. 8 shows a top view of an arc support structure for an educational globe device;

FIG. 9 shows a bottom view of the control circuit assembly within the base of the educational globe device;

FIG. 10 shows a front view of an educational globe base;

FIG. 11 depicts a bottom view of the Bluetooth speaker output and LED light combination; and

FIG. 12 depicts a front view of the Bluetooth speaker output and LED light combination.

### DETAILED DESCRIPTION OF THE INVENTION

The present disclosure is to be considered as an exemplification of the invention, and is not intended to limit the invention to the specific embodiments illustrated by the figures or description below.

The terminology used herein is for the purpose of describing particular embodiments only and is not intended to be limiting of the invention. As used herein, the term “and/or” includes any and all combinations of one of more of the associated listed items. It will further be understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs.

Disclosed herein is an educational device primarily consisting of a globe with an illuminated light display of astronomical constellations, with wireless speaker capabilities, for playing, education, or entertaining media.

In one embodiment, the educational globe device is designed with the map of the world.

In one embodiment, the educational globe device has a sensor on its base, which is capable of detecting darkness in order to instruct the lights installed within the globe to illuminate automatically, without having to manually turn the light display on.

In one embodiment, the educational globe device includes small openings for light to project from within the globe in a layout corresponding to star constellations.

In one embodiment, the globe is rotatably engaged with an arc support extending from the base of the globe at two engagement points.

In one embodiment, the globe is rotatably engaged with an arc support extending from the base of the globe at one engagement point.

In one embodiment, the educational globe device has a speaker within the globe itself, with two locations for sound output on the globe itself.

In one embodiment, the educational globe device has an on/off switch on the base of the globe, allowing a user to turn the globe on or off, as desired.

In one embodiment, the educational globe device has a Bluetooth connection enabling system within the base of the globe, allowing for Bluetooth connection with a range of devices, including computers, mobile devices such as cellphones, and the like, in order for media to be transmitted to and be played by the speaker within the globe.

In one embodiment, the educational globe device of the present invention has a WiFi connection enabling system within the base of the globe, allowing for WiFi connection with a range of devices including computers, mobile devices such as cellphones, and the like in order for media to be transmitted to and be played by the speaker within the globe.

In one embodiment, the educational globe device variates in its illumination patterns, in coordination with the sound emitted from the speaker.

In one embodiment, the educational globe device is pre-programmed with a variety of songs and media enabling the globe to emit sounds without requiring a connection to a secondary device either via Bluetooth or WiFi.

In one embodiment, the base of the globe has a power input slot to connect the globe to a power source. The is either plugged into the power source in order to “power on” or can be charged by the power source for use while disconnected from the power source.

In one embodiment, the globe has an on/off switch for the light display and a separate on/off switch for the speaker.

In one embodiment, the light display can be set to a timer to shut the light display off after a desired interval of time has passed.

In one embodiment, the globe is able to play media emitted by FM/AM radio channels.

The present invention will now be described by referencing the appended figures representing preferred embodiments.

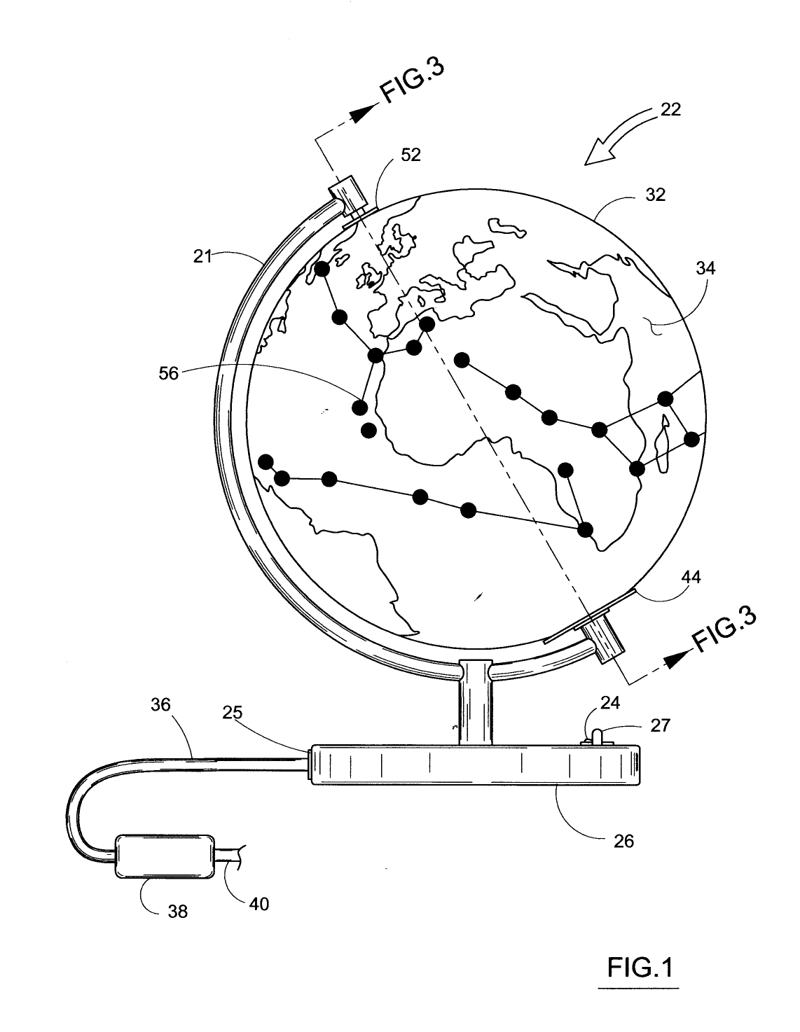

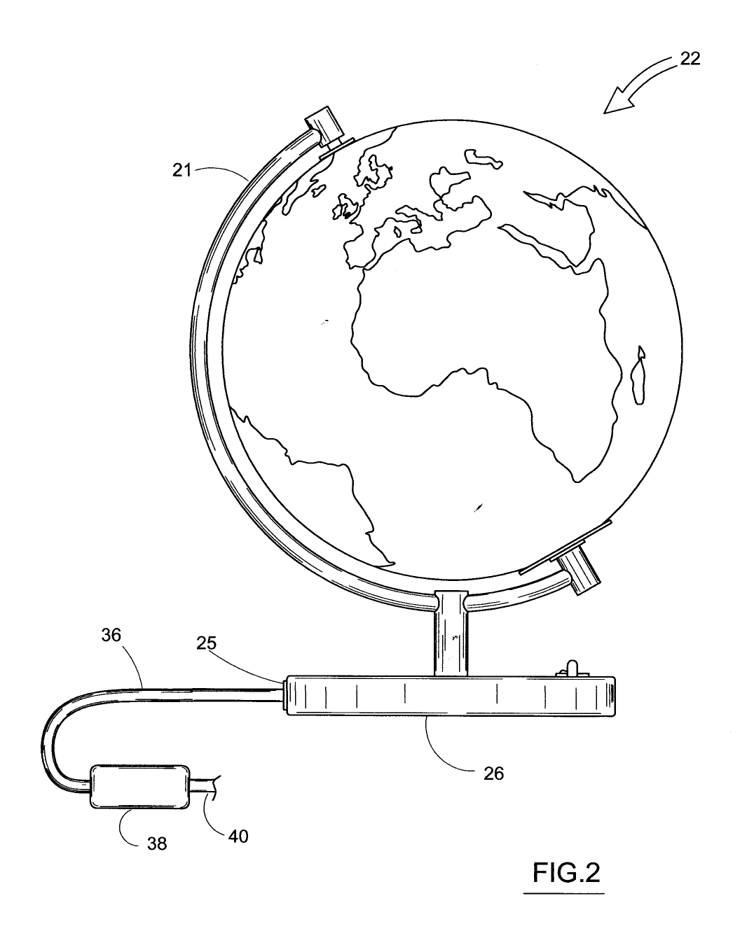

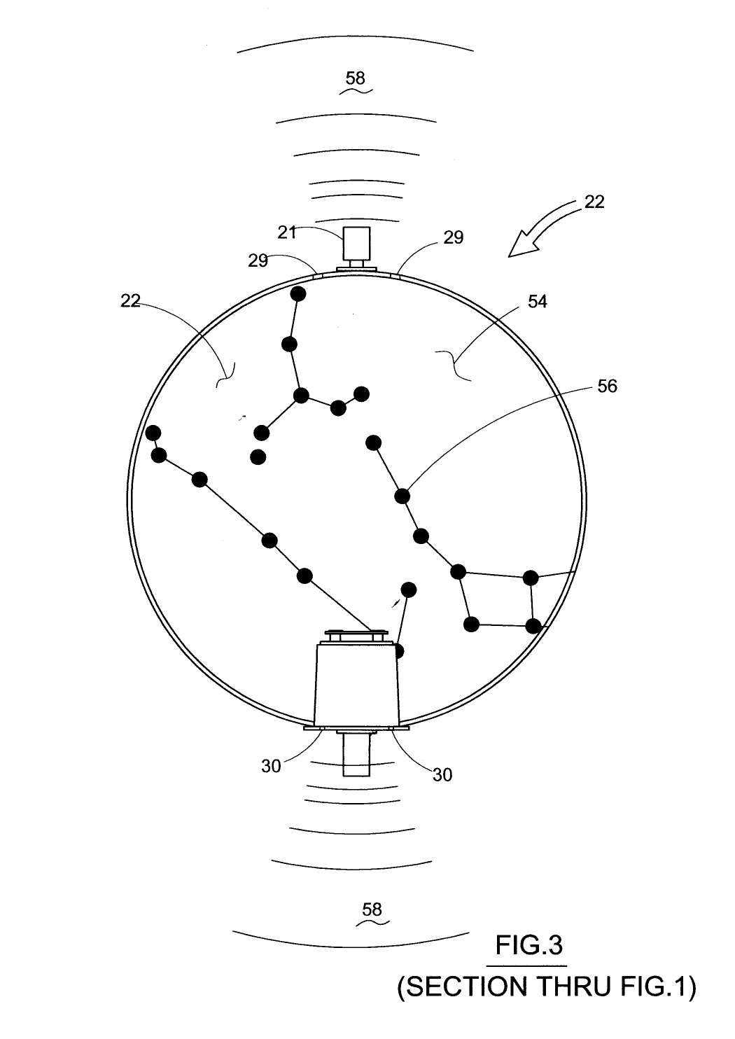

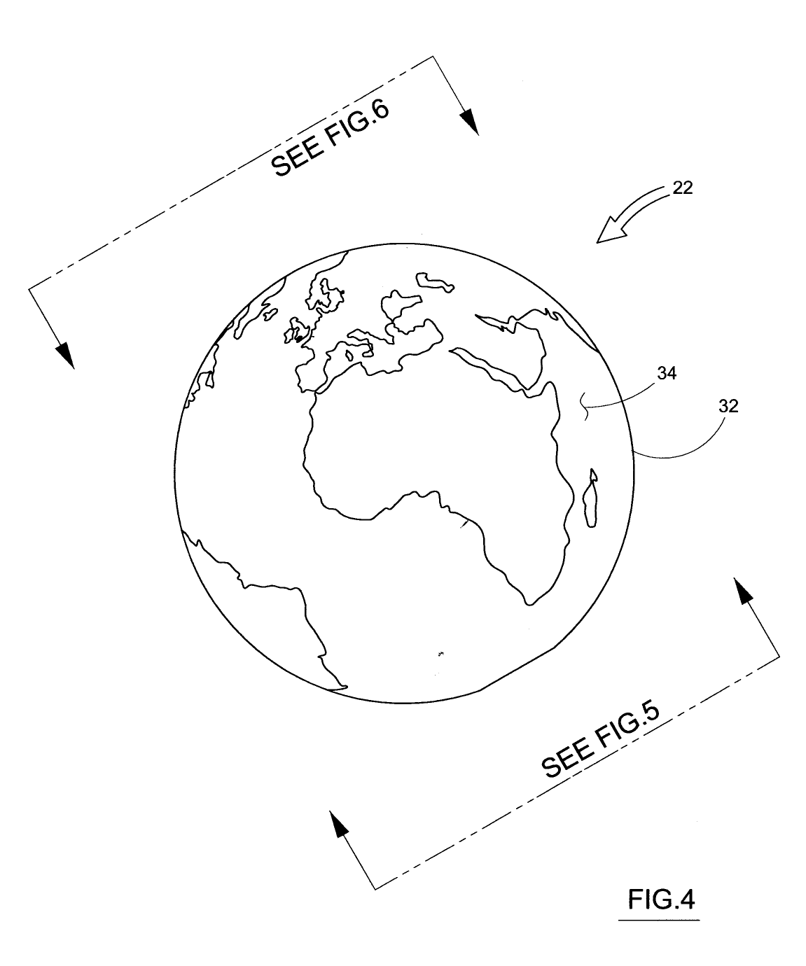

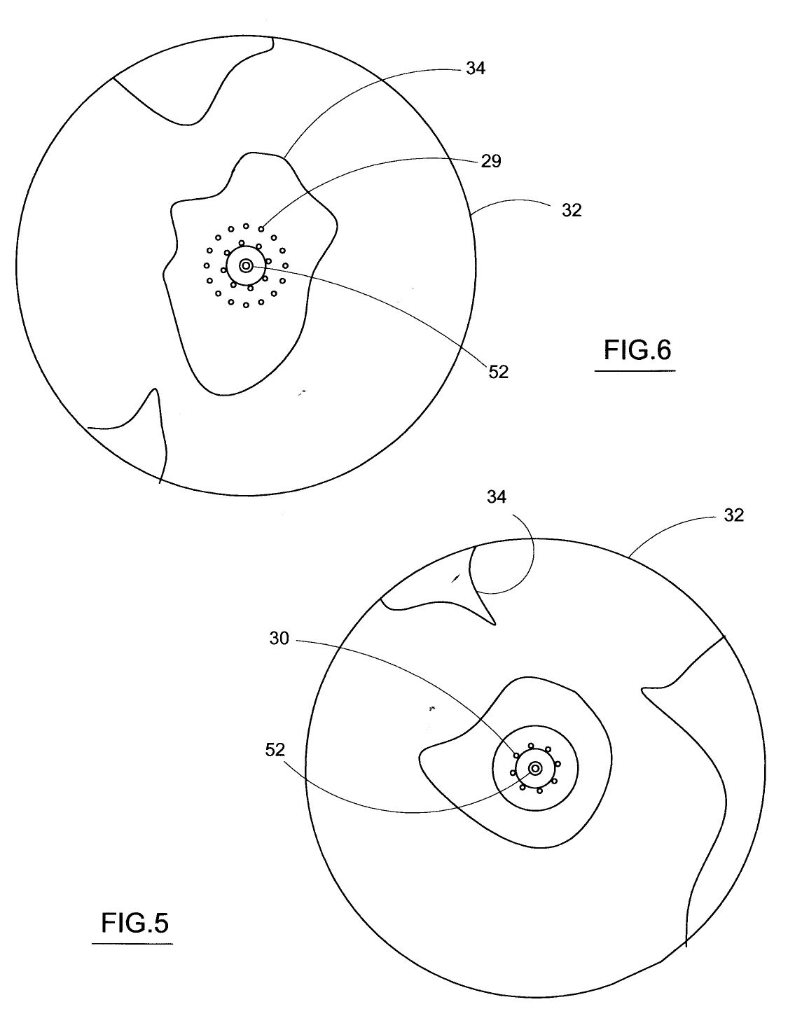

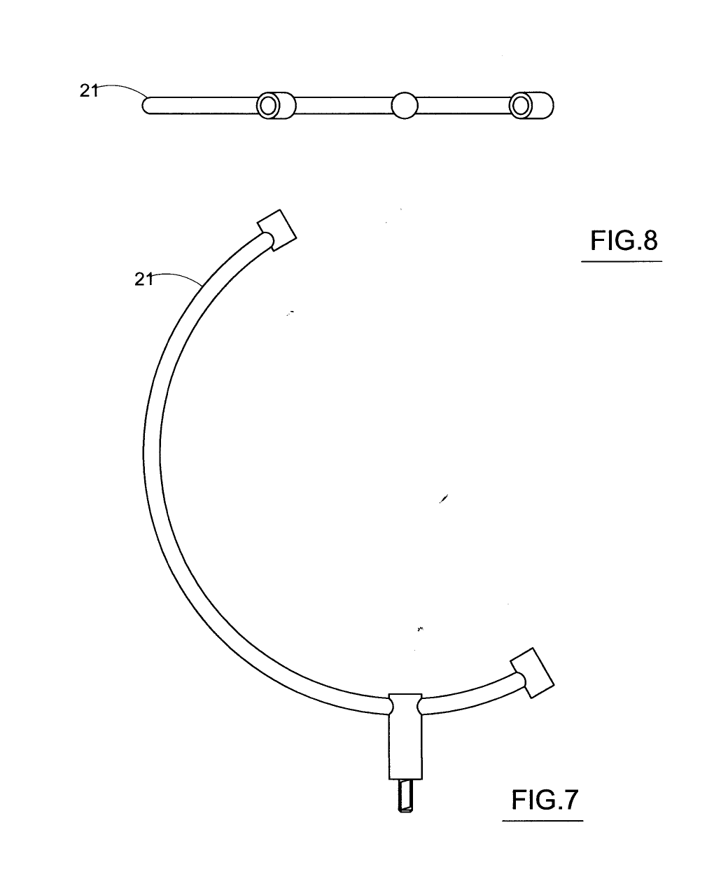

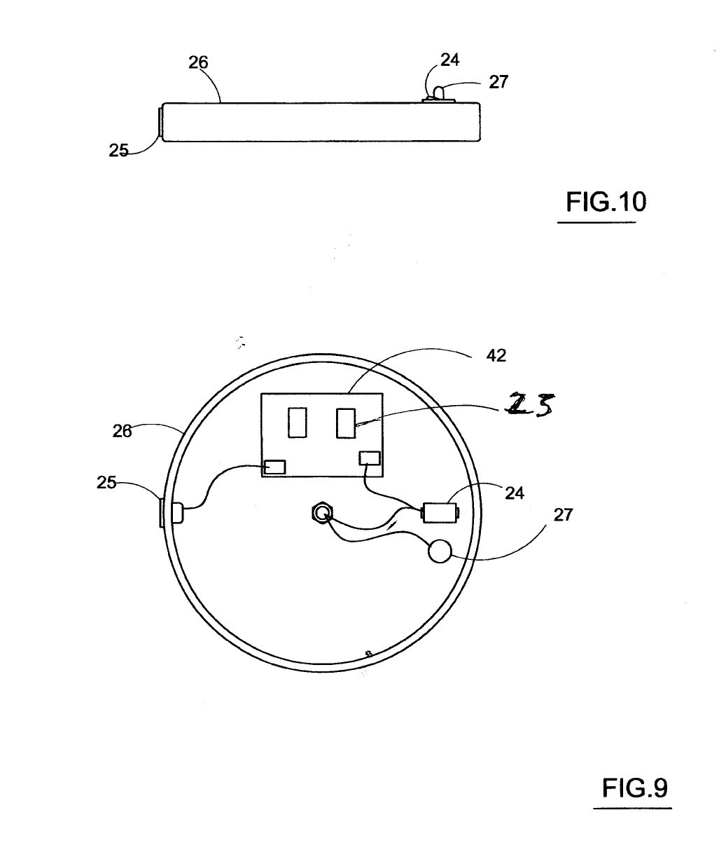

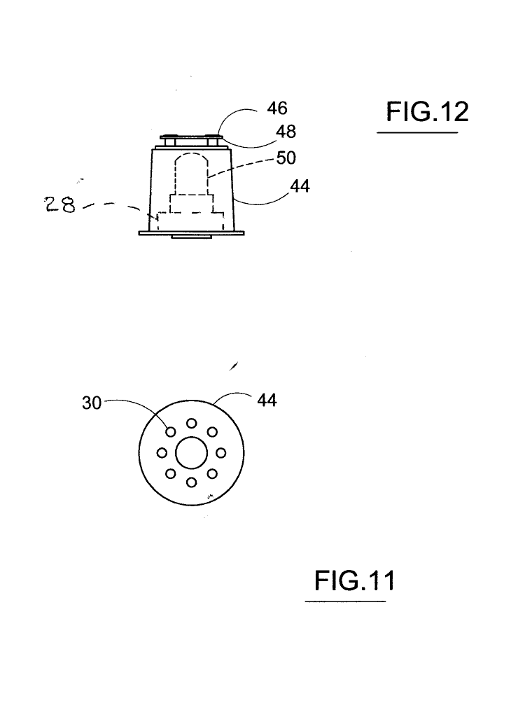

Referring now to FIGS. 1-12, there is generally depicted a globe speaker device 22 according to a preferred embodiment of the present invention. Globe speaker device 22 generally includes a globe arc support 21, base 26, Bluetooth speaker 28, control circuit board 42, upper light and sound apertures 29, and lower light and sound apertures 30.

In a preferred embodiment, globe arc support 21 holds the exterior surface of the globe 32 at two opposing locations. Globe arc support 21 permits globe 22 to be rotatable along a pivotable axis.

Base 26 of globe speaker 22 generally includes a power on/off switch 24, a power sensor lamp 27, an AC adaptor port 25, a control circuit board 42, a power supply cable 36, and provides a stage for stability of globe speaker 22 via arc support 21.

In one embodiment, exterior surface 32 of globe speaker 22 is embossed with graphics 34 of the map of the world.

In one embodiment, globe speaker 22 has a Bluetooth housing 44 within the interior surface of the globe 54. Bluetooth housing 44 possesses a projection lamp 50 within its body and has a Light Emitting Diode (LED) 46, as well as a LED circuit board 48 on its outer surface. In some embodiments, Bluetooth housing 44 further possesses projecting light and sound apertures 29 and 30. Sound and light waves 58 are emitted out of speaker globe 22 through sound and light apertures 29 and 30 (FIG. 3).

Power supply cable 36 allows for AC power supply 40 to flow through the cable and possesses a power transformer 38.

The present invention further discloses a pivot bearings 52 to allow the globe to be rotatable along an axis determined by the positioning of bearings 52 along arc support 21.

In some embodiments, globe speaker 22 possesses light sensitive graphics 56 (FIG. 1) in varying layouts, enabling the teaching of different educational objectives.

What is claimed is:

1. An educational globe speaker device comprising:
an educational globe displaying world geography;
wherein said globe is pivotably attached to a base along an axis, possesses a speaker within the inner surface of the globe with an output source for sound waves, and exhibits an illuminated light display of various educational patterns;
wherein said light display is enabled by a power-on mechanism; and
wherein said base houses a device enabled to receive and play transmitted media; and
wherein said base houses a power input source.

2. The globe of claim 1 wherein said power-on mechanism is a sensor capable of detecting darkness in order to instruct the lights installed within the globe to illuminate automatically, without the need to manually turn the light display on.

3. The globe of claim 1 wherein said power-on mechanism is an on/off button.

4. The globe of claim 1 wherein said illuminated light display corresponds to star constellations.

5. The globe of claim 1 wherein said globe is rotatably engaged to said base by an arc support.

6. The globe of claim 1 wherein said globe is engaged with said arc support at two engagement points.

7. The globe of claim 1 wherein said globe is engaged with said arc support at one engagement point.

8. The globe of claim 1 wherein said device, enabled to receive and play transmitted data, is a Bluetooth connection enabling system.

9. The globe of claim 1 wherein said device, enabled to receive and play transmitted data, is a WiFi connection enabling system.

10. The globe of claim 1 wherein said device, enabled to receive and play transmitted data, allows for the transmission of FM/AM radio waves.

11. The globe of claim 1 wherein said device, enabled to receive and play transmitted data, is pre-programmed with a variety of songs and media enabling the globe to emit sounds without requiring a connection to a secondary device either via Bluetooth of WiFi.

12. The globe of claim 1 wherein said power input source allows for the connection of the base to a power source input in order to power on the globe speaker.

13. The globe speaker of claim 1 wherein said power input source allows a user to charge the globe speaker device for use while disconnected from the power source.

14. The globe speaker of claim 1 wherein said base of the globe has an on/off switch for the light display.

15. The globe speaker of claim 1 wherein said base of the globe has an on/off switch for the speaker.

16. The globe speaker of claim 1 wherein the light display is enabled with a timer in order to turn off the light display after a desired interval of time has passed.

17. The globe speaker of claim 1 wherein the speaker is enabled with a timer in order to turn off the speaker after a desired interval of time has passed.

18. An educational globe speaker device comprising:
an educational globe displaying a set geographical map;
wherein said globe is rotatably attached to a base, possesses a speaker within its body with built-in output sources for sound, and an illuminated light display of various light patterns; and
wherein said base houses a device enabled to receive transmitted media; and
wherein said base houses a power input source.

19. The globe of claim 18 wherein said light display is enabled by a sensor.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)
